(19) United States
(12) Patent Application Publication
(10) Pub. No.: US 2011/0072913 A1
(43) Pub. Date: Mar. 31, 2011

(54) Apparatus for determining a process variable of a liquid in a process plant

(76) Inventor: Jörg Uhle, Limbach-Oberfrohna (DE)

(21) Appl. No.: 12/956,918

(22) Filed: Nov. 30, 2010

(30) Foreign Application Priority Data
Feb. 12, 2009 (DE) 10 2009 047 405.6

(51) Int. Cl. G01N 1/20

(52) U.S. Cl. 73/863.41

(57) ABSTRACT

The invention relates to an apparatus for determining a physical or chemical process variable of a liquid in a process plant having at least one pipeline (3), in which the liquid flows, at least at times. The apparatus comprises: At least one sensor (1) and at least one communication unit (2). The sensor (1) comprises: At least one sensor element (11) for taking measurement data representing the process variable; a first electronics unit (12) for storing the measurement data taken with the sensor element (11); and a first coil arrangement (13) having at least a first coil. The communication unit (2) comprises: A second electronics unit (22) and a second coil arrangement (23) having at least a second coil. The first coil arrangement (13) and the second coil arrangement (23) form an inductive interface, which serves for transmission of measurement data from the sensor (1) to the communication unit (2) and/or transmission of energy from the communication unit (2) for the sensor (1). The invention is distinguished by the sensor (1) being freely movable in the liquid.

The present invention relates to an apparatus for determining at least one physical or chemical, process variable of a liquid in a process plant, which has at least one pipeline, in which the liquid flows, at least at times, wherein the apparatus comprises: At least one sensor; and at least one communication unit; wherein the sensor comprises: At least one sensor element for taking measurement data representing the process variable; a first electronics unit for storing the measurement data taken with the sensor element; and a first coil arrangement having at least a first coil; wherein the communication unit comprises: A second electronics unit; and a second coil arrangement having at least a second coil; and wherein the first coil arrangement and the second coil arrangement form an inductive interface, which serves for transmission of measurement data from the sensor to the communication unit and/or the transmission of energy from the communication unit to the sensor. The term, “process plant” refers, in such case, to a combination of containers and pipelines or to a pipeline system, wherein, in the process plant, one or a number of liquids participate in a chemical or physical process. A coil arrangement comprises one or a number of coils with equal or different numbers of windings, or turns. The process variable to be determined is one or a number of the variables, temperature, pH value, redox potential, turbidity, conductivity or substance concentration.

Known from the state of the art for determining physical or chemical process variables of liquids are sensors composed of a sensor element and a housing, which are applied via a process connection to the pipeline or the container containing the liquid. In such case, the sensor element protrudes into the pipeline or the container, while the housing is located outside the process. Especially advantageous are sensors, which forward the measurement data to a superordinated unit via a galvanically isolated interface. Such sensors with an inductive interface are available from the assignee under the name Memosens in a large number of embodiments for wide variety of process variables.

In the case of large process plants, correspondingly large numbers of sensors must be installed, in order to be able to determine the desired process variables in all required regions. From this, there results, on the one hand, the disadvantage, that a correspondingly large number of process connections is required. This represents a risk as regards density and hygiene, which is, above all, problematic in pharmaceutical or food process plants, since these must conform to strict hygienic standards. On the other hand, a large number of sensors means correspondingly high costs.

An object of the invention is to provide a cost effective apparatus for determining a physical or chemical process variable of a liquid at a plurality of locations within a process.

The object is achieved by the features that: The sensor is movable freely in the liquid; the sensor has a closed housing, which has, at least sectionally, a material, which allows magnetic fields to pass through; the sensor contains an energy storer, which assures energy supply of the sensor element and the first electronics unit;

the communication unit has a tubular segment, which is inserted into the pipeline, and which has, at least in a section, a material, which allows magnetic fields to pass through; and the first coil arrangement and the second coil arrangement are embodied in such a manner that the inductive interface is produced, at least at times, when the sensor is located in the tubular segment.

The sensor preferably moves along with the liquid, so that it follows the process flow and, in the case of a circulatory system, passes through such repeatedly. The sensor, thus, reaches each region of a process plant that is reached by the liquid. In this way, measurement data can be taken in these regions, without each region having to be equipped separately with a fixedly installed sensor element. This saves, on the one hand, costs and avoids, on the other hand, the application of process connections, which, for example, in the foods industry, represent hygienic risk factors.

While the sensor is located in the communication unit, the measurement data stored in the sensor are transmitted to the electronics unit of the communication unit, the energy storer of the sensor is recharged, and/or parameter data are transmitted to the sensor.

The first electronics unit is, for example, so embodied, that it not only stores the measurement data, but, instead, also processes, evaluates and, in given cases, rejects, data, so that the transmission of a reduced amount of data via the inductive interface is enabled, which offers the advantage of a shorter residence time of the sensor in the tubular segment of the communication unit. The first coil arrangement of the sensor is, in the simplest case, an annular first coil. The second coil arrangement of the communication unit is, for example, a second coil, which radially surrounds the tubular segment. Preferably, the second coil arrangement contains a number of coil pairs of different orientation, so that the sensor receives the magnetic field of the second coil arrangement independently of its orientation in the tubular segment. The energy storer is, for example, a disposable battery, a rechargeable battery, or a capacitor.

A first embodiment of the invention includes, that the housing of the sensor at has least one opening, via which the sensor element is in physical and/or optical contact with the liquid for taking the measurement data, wherein the opening is embodied in such a manner, that a penetration of the liquid into the sensor is prevented. The opening is, for example, a window, through which light be transmitted from the sensor into the surrounding medium and scattered light can result. This embodiment is especially of advantage in the case of a turbidity sensor. In another embodiment, the opening is a cavity in the housing of the sensor, with the sensor element lying behind the cavity. For example, the sensor element is an electrode, which, in this way, contacts the surrounding liquid and ascertains a chemical property, such as its pH value.

In an additional embodiment of the apparatus of the invention, the communication unit includes a hold/release apparatus, which holds the sensor in the tubular segment of the communication unit for the transmission of parameter data and/or energy and/or measurement data, and which releases the sensor, when the transmission of the parameter data and/or the energy and/or the measurement data is finished.

If the sensor moves with the liquid medium, it resides only for a certain time period in the tubular segment of the communication unit, so that the time, during which data- or energy transfer is possible, is limited. The faster the liquid flows, the shorter is the available time. The hold/release apparatus has, consequently, the task of holding the sensor sufficiently long in the tubular segment, that the transfer can be finished. For example, the hold/release apparatus comprises baffles, which lessen the tube diameter and, thus, prevent a passing of the sensor. Control of the hold/release apparatus is, for example, possible by the second electronics unit, which by the interaction of the second coil arrangement with the first coil arrangement in the sensor, detects presence of the sensor and activates the hold apparatus, in case a transmission of energy or data is necessary.

Another embodiment provides that the second coil arrangement is embodied in such a manner, that the transmission of the measurement data and/or the energy is enabled; while the sensor moves through the tubular segment.

If the liquid and, thus, the sensor, moves only with a small velocity through the tubular segment, this enables a sufficiently long second coil arrangement, that the sensor does not have to be stopped by a corresponding apparatus for the energy- and/or data transfer.

In an advantageous embodiment, the pipeline includes a detour passageway, which extends essentially parallel to the tubular segment of the communication unit and which is embodied in such a manner, that an entering of the sensor into the detour passageway is prevented and that the liquid at least then flows through the detour passageway, when the sensor is located in the tubular segment of the communication unit. If the sensor is located in the tubular segment of the communication unit, then the tube cross section in the region of the sensor available for the liquid is lessened. In the case of some applications this is not allowable, so that, in this case, a detour passageway is provided, through which the liquid can flow beside the tubular segment. For example, a valve opens this detour passageway, when the sensor enters into the tubular segment of the communication unit, and closes the detour passageway, as soon as the sensor has left the tubular segment.

In an additional, advantageous embodiment, the communication unit has available an injection- and/or ejection apparatus, via which the sensor is introducible into the process plant and/or removable from the process plant.

The injection- and/or ejection apparatus comprises preferably two tube sections, which branch from the tubular segment, a pipeline or other part of the process plant and are sealed from such part of the process plant, for example, by a sliding door- or baffle apparatus. If, for example, a sensor replacement or the introduction of an additional sensor is necessary, the relevant tube section, pipeline, etc. is opened toward the process, so that the new sensor can be introduced or the sensor to be replaced can be removed. A sensor replacement, or the introducing, or removing, of sensors is, thus, possible without interfering with the process.

In the case of an additional embodiment of the apparatus of the invention, at least a first sensor and a second sensor are introduced into the process plant and the first sensor and the second sensor take redundant measurement data or take measurement data at one point in time, in each case, at different locations in the process plant.

For redundant data taking, an option is to introduce a number of sensors simultaneously into the process, so that they operate as neighbors in the medium and take measurement data in the same region of the process plant. It is likewise possible to introduce a number of sensors spaced from one another in the process, so that is assured, that the process variable present in a region of the process plant is ascertained at certain intervals. Read-out of the measurement data of the sensors can occur in of such communication unit.

Another advantageous embodiment of the invention provides, that the apparatus has at least a first communication unit and at least a second communication unit, which the sensor passes on a predetermined path, so that, from the time period measured from the passing of the first communication unit until the passing of the second communication unit, the flow velocity of the liquid can be ascertained. Since the sensor moves with the liquid, by determining the velocity of the sensor for the time period, which the sensor requires to move from a first to a second communication unit, also the velocity of the liquid in this section of the process plant is given. Furthermore, from the second communication unit, the flow direction of the liquid between the first and the second communication unit is ascertainable. The number of communication units, which are arranged in the process plant, depends, for example, on their size and/or on the process.

Especially, in the case of widely extended process plants and/or in the case of pipelines of great length, the presence of a plurality of communication units is advantageous, since, in this way, additionally the measurement data, which the sensor takes, can be read out more frequently than when only one communication unit would be present in the whole process plant.

In a preferred embodiment, the sensor is essentially of rotationally symmetric shape. For example, the sensor is a ball or an ellipsoid.

In a preferred embodiment of the invention, the process variable is a pH value, a redox potential, a conductivity, a temperature or a turbidity of the liquid, or a concentration of a material in the liquid. Of course, it is to be understood that this listing of process variables is only for purposes of illustration and that other process variables, besides those listed, are suitable for the invention.

The invention will now be explained in greater detail on the basis of the appended drawing, the figures of which relate to the sensor and the communication unit. The figures of the drawing show as follows:

FIG. 1 a ball shaped sensor of the invention;

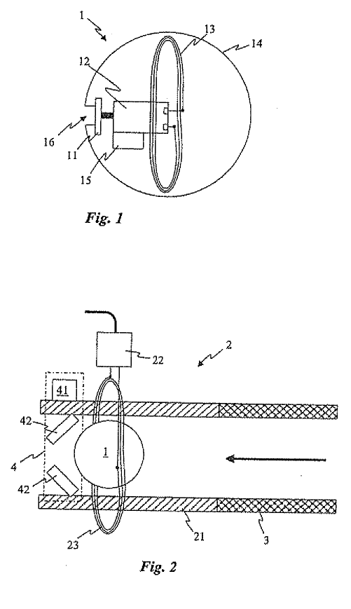

FIG. 2 a communication unit of the invention with a sensor; and

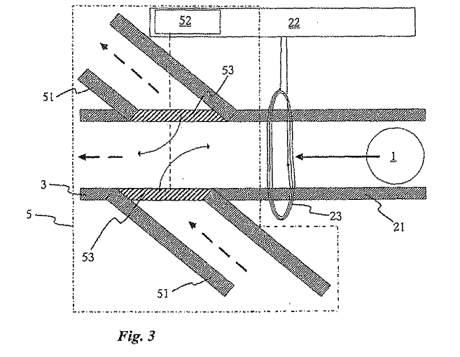

FIG. 3 a communication unit with an injection, and ejection, apparatus.

FIG. 1 shows a ball shaped sensor 1 having an opening 16 in the housing 14. The opening 16 is, in such case, in the form a blind hole like cavity, wherein the floor of the cavity is formed by the sensor element 11. The liquid, which surrounds the sensor 1 while in use in the process plant, penetrates, thus, only up to the sensor element 11, while the remaining elements of the sensor 1 in the housing 14 are protected from the liquid. In an alternative variant (not shown), the opening 16 in the housing 14 of the sensor 1 is sealed by a transparent window, wherein the material of the window is, for example, a glass or a plastic material. The housing 14 of the sensor 1 is likewise completely or partially manufactured from a material transmissive for magnetic fields, for example, the housing is completely of plastic. The shape of the sensor 1 is so selected, that it possesses good flow characteristics and is robustly resistant to damage. Besides a ball is, for example, an ellipsoid or other rotationally symmetric body is suitable, wherein such preferably has no corners.

The sensor element 11 is connected with the first electronics unit 12, in which the measurement data taken by the sensor element 11 are at least stored and, in given cases, evaluated, or compressed. Preferably, stored in the electronics unit 12, moreover, are parameters for calibrating the sensor element 11. Via the first coil arrangement 13, the measurement data stored in the electronics unit 12 are capable of being read out, wherein, for this, contact with a coil arrangement of a read-out apparatus is necessary. The first coil arrangement is, in the simplest case, a single, annular coil. Other embodiments are, however, likewise possible. For example, the first coil arrangement 13 can be constructed of a plurality of annular coils of different orientation, so that the data stored in the electronics unit 12 can be transmitted independently of the orientation of the sensor 1 within a, for example, annular, secondary winding.

Through the energy storer 15, the electronics unit 12 as well as the sensor element 11 while accommodating measurement data, or while used in the process plant, are supplied autarkically with energy. The energy storer 12 is, for example, a rechargeable battery, which is rechargeable via the inductive interface.

The process variable to be determined with the sensor element 11 is not limited to an single process variable. As a function of the embodiment of the sensor 1 and/or the sensor element 11, a measuring of a plurality of different process variables is likewise possible with the same sensor 1. For example, the ball shaped sensor 1 can be equipped with oppositely lying openings 16, wherein behind the openings 16, in each case, a sensor element 11 is arranged for determining a desired process variable.

FIG. 2 discloses a preferred embodiment of the communication unit 2 for the transmission of data and/or energy between the sensor 1 and a superordinated unit. Communication unit 2 includes, for this, a second electronics unit 22, as well as a second coil arrangement 23, which forms a contactless interface with the first coil arrangement 13 of the sensor 1. Communication unit 2 includes, furthermore, a tubular segment 21, which is inserted into a pipeline 3, which is a component of the process plant. In order to enable the inductive coupling between the first coil arrangement 13 and the second coil arrangement 23, the tubular segment 21 is at least sectionally manufactured from a material, through which magnetic fields can pass. The tubular segment 21 is, thus, for example, completely manufactured of plastic or it is a steel tube, which has one or a number of sections made of a magnetic field transmissive material. The second coil arrangement 23 is, for example, a wire wound spirally around the tubular segment 21, wherein the tubular segment 21 is surrounded completely or partially by the second coil arrangement 23. Alternatively, the second coil arrangement 23 is composed of a plurality of coil pairs, which are arranged in such a manner around the tubular segment 21, that the inductive interface is produced in the case of almost any position of the sensor 1 within the tubular segment 21 of the communication unit 2.

Optionally, the communication unit 2 includes a hold/release apparatus 4, which serves to hold the sensor 1 in the tubular segment 21 until the transfer of data or energy is finished. This is implemented, for example, by holding elements 42 in the form of baffles, which, in the resting state, contact the inner wall of the tubular segment 21 and, when required, can be swung out, so that the diameter of the tubular segment 21 is lessened in such a manner, that the sensor 1 the hold/release apparatus 4 cannot pass. For control of the holding elements 42, either the second electronics unit 22 or a separate control unit 41 for the hold/release apparatus 4 is provided. The form of the hold/release apparatus 4 is not limited to the shown embodiment with baffles as holding elements 42.

FIG. 3 shows the tubular segment 21 of a communication unit 2 with following injection/ejection apparatus 5, via which the sensor 1 is removable from the process or introducible into the process. The injection/ejection apparatus 5 includes two tube sections 51, wherein, in each case, a tube section 51 is arranged at an acute angle in, or against, the flow direction relative to the pipeline 3. It is, in such case, of lesser importance, how the two tube sections 51 are arranged relative to one another, i.e. at what distance from one another and on which side of the pipeline 3 each is arranged. The tube sections 51 are, in each case, sealed by a mechanically or electrically movable baffle 53 relative to the pipeline 3. A baffle 53 is only opened, when a sensor 1 is to be introduced into, or removed from, the pipeline 3. Control of the baffles is accomplished preferably via a control unit 52 of the injection/ejection apparatus 5, wherein the control unit 52 can be integrated into the second electronics unit 22 of the communication unit 2. Control unit 52 can, however, also be present separated from the second electronics unit 22, especially when the injection/ejection apparatus 5 does not adjoin the tubular segment 21 of the communication unit 2, but, instead, is arranged in another region of the process plant.

It is to be noted here, that the number of sensors 1 and communication units 2 is, in no way, limited to one, but, instead, as a function of the application, any number of sensors 1 and communication units 2 can be introduced into the process plant. Thus, for example, an option is a process plant with only one communication unit 2 but two or more sensors 1.

### LIST OF REFERENCE CHARACTERS

1 sensor
11 sensor element
12 first electronics unit
13 first coil arrangement
14 housing
15 energy storer
16 opening
2 communication unit
21 tubular segment
22 second electronics unit
23 second coil arrangement
3 pipeline
4 hold/release apparatus
41 control unit
42 holding element
5 injection/ejection apparatus
51 tube section
52 control unit
53 baffle

1-10. (canceled)

11. An apparatus for determining a physical or chemical process variable of a liquid in a process plant having at least one pipeline, in which the liquid flows, at least at times, the apparatus comprises:
at least one sensor; and
at least one communication unit; wherein:
said sensor comprises: at least one sensor element for taking measurement data representing the process variable; a first electronics unit for storing the measurement data taken with said sensor element; and a first coil arrangement having at least a first coil;
said communication unit comprises: a second electronics unit and a second coil arrangement having at least a second coil;
said first coil arrangement and said second coil arrangement form an inductive interface, which serves for transmission of measurement data from said sensor to said communication unit and/or transmission of energy from said communication unit to said sensor;
said sensor is movable freely in the liquid;
said sensor has a closed housing, which comprises, at least sectionally, a material, through which magnetic fields can pass;
said sensor contains an energy storer, which assures energy supply of said sensor element and said first electronics unit;
said communication unit has a tubular segment, which is inserted into the pipeline, and which comprises, at least in a section, a material, through which magnetic fields can pass; and
said first coil arrangement and said second coil arrangement are embodied in such a manner, that the inductive interface is produced, at least at times, when said sensor is located in said tubular segment.

12. The apparatus as claimed in claim 11, wherein:
said housing of said sensor has at least one opening, via which said sensor element is in physical and/or optical contact with the liquid for taking the measurement data; and
said opening is embodied in such a manner, that penetration of the liquid into said sensor is prevented.

13. The apparatus as claimed in claim 11, wherein:
said communication unit includes a hold/release apparatus, which holds said sensor in said tubular segment for transmission of parameter data and/or energy and/or measurement data, and which releases said sensor, when transmission of the parameter data and/or the energy and/or the measurement data is finished.

14. The apparatus as claimed in claim 11, wherein:
said second coil arrangement is embodied in such a manner, that transmission of the measurement data and/or the energy is enabled, while said sensor is moving through said tubular segment.

15. The apparatus as claimed in claim 11, wherein:
the pipeline has a detour passageway, which extends essentially parallel to said tubular segment of said communication unit and which is embodied in such a manner, that an entering of said sensor into said detour passageway is prevented and that the liquid flows through said detour passageway, at least when said sensor is located in said tubular segment of said communication unit.

16. The apparatus as claimed in claim 11, wherein:
said communication unit has available an injection, and/or ejection, apparatus, via which said sensor is introducible into the process plant and/or removable from the process plant.

17. The apparatus as claimed in claim 11, wherein:
at least a first sensor and a second sensor are introduced into the process plant; and
said first sensor and said second sensor take redundant measurement data or take measurement data at a point in time, in each case, at different locations in the process plant.

18. The apparatus as claimed in claim 11, wherein:
the apparatus has at least a first communication unit and at least a second communication unit, which said sensor passes on a predetermined path, so that, from the time period between passing said first communication unit and passing said second communication unit, the flow velocity of the liquid is ascertainable.

19. The apparatus as claimed in claim 11, wherein:
said sensor is of rotationally symmetric shape.

20. The apparatus as claimed in claim 11, wherein:
the process variable is a pH value, a redox potential, a conductivity, a temperature or a turbidity of the liquid, or a concentration of a material in the liquid.
